(19) United States
(12) Patent Application Publication
(10) Pub. No.: US 2008/0313943 A1
(43) Pub. Date: Dec. 25, 2008

(54) Device for securing identification

(76) Inventor: Kathy Fragnoli, Dallas, TX (US)

Correspondence Address: JEFFREY H. RODDY, 525 ROYAL CREST DRIVE, RICHARDSON, TX, 75081, US

(21) Appl. No.: 11/820,419

(22) Filed: Jun. 19, 2007

(51) Int. Cl. G09F 3/18

(52) U.S. Cl. 40/661

(57) ABSTRACT

A device for securing identification to a mounting surface includes an elongated mounting device having a front surface and a rear surface and at least one opening between the surfaces wherein an identification means may be inserted or removed and an adhesive applied to the rear surface of the mounting device for adhering the mounting device to the mounting surface.

### BACKGROUND OF THE INVENTION

1. Field of the Invention

This invention relates generally to a sleeve into which means of identification such as a business card or distinctive logo may be inserted and that may be affixed to a mounting surface and to a method of affixing to a mounting surface a sleeve for receiving means of identification.

2. Related Art

Personal items such as mobile telephones, personal digital assistants (PDA), laptop computers, documents, brochures, and portfolios are often generic in appearance, particularly if the owner's name is not obviously displayed on the device or item. Mistakes in the identity of the owner of such a device may occur and an unintended person may pick up the wrong device if the owner is not clearly identified.

Such personal items are frequently small and may be overlooked when the owner leaves a public area such as an airport check-in or a conference room. The generic appearance of such devices may hinder the owner's efforts to locate the device or a finder's efforts to locate the owner if the identity of the owner is not obvious.

Brochures, portfolios and similar documents are often used to deliver a message or to provide information from a person that desires to be readily identified by the recipient of the information. It may be desirable to secure a business card or other form of identification to a document, brochure or a portfolio or the like such that the identifying device can be readily removed and separately stored. The use of staples, paper clips, tape, slits in the paper, or the like result in a sloppy appearance and may damage the identifying document and/or underlying surface.

### SUMMARY OF THE INVENTION

The present invention provides a device and a method for securing identification such as a business card to a mounting surface that provides a unique identification for the object.

In accordance with an aspect of the present invention, the present invention provides for a device and method for removably securing a means of identification to a mounting surface that includes an elongated sleeve having a front surface and a rear surface and a perimeter, the front surface being attached to the rear surface by at least a portion of the perimeter forming a pocket, said pocket having at least one opening between the front surface and the rear surface, and an adhesive on the back of the rear surface to adhere the rear surface to the mounting surface.

The present invention further provides a device and a method for removably securing identification to a document or paper which does not mutilate the identification or the mounting surface when the identification is removed.

The present invention further provides a device and a method for securing identification to a mounting surface that provides a message thereon that is separate from the identification.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 a plan view of a rectangular sleeve according to an embodiment of the invention;

FIG. 2 is a plan view of a device for securing a business card to a surface, according to an embodiment of the present invention, with a business card secured therein;

FIG. 3 is a plan view of a device for securing a business card to a surface, according to an embodiment of the present invention, with a business card secured therein;

FIG. 4 is an isometric view of a device of FIG. 3, for securing a business card to a surface according to an embodiment of the present invention, affixed to a portable electronic device.

### DESCRIPTION OF THE PREFERRED EMBODIMENTS

In the following description, numerous details are set forth to provide an understanding of the present invention. It should be understood by those of ordinary skill in the art that the present invention may be practiced without these details and that numerous variations or modifications from the described embodiments may be possible. The specific embodiments discussed herein are merely illustrative of specific ways to make and use the invention and do not delimit the scope of the present invention.

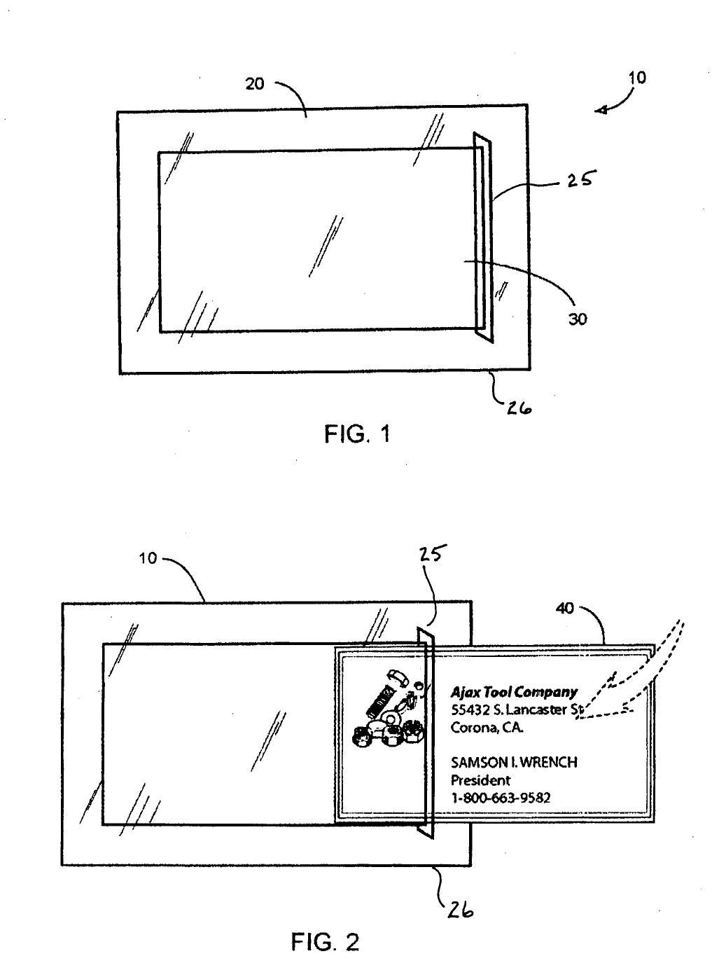

Referring generally to FIG. 1 and FIG. 4, the present invention relates to a mounting device 10 and a method for securing an identification device to a mounting surface 50.

Referring generally to FIG. 1, the mounting device 10 may be a sleeve manufactured by attaching a front surface 30 to a back surface 20 with an opening there between 25 for insertion of an identification device 40 such as a business card or other identification tag. In an alternative embodiment of the invention, the mounting device may be a layer of transparent or translucent material folded and sealed to form a sleeve.

The mounting device 10 may have any number of sides comprising its perimeter 26 and a variety of shapes 15.

The mounting device 10 may have any number of openings 25 for insertion of an identification device 40 such as a business card or logo.

The front face of the mounting device 10 may have an ornate design.

The front face of the mounting device 10 may be printed with words, letters, numbers, symbols or any combination of characters and/or designs.

The front surface of the mounting device 30 may be a transparent material to permit the contents of the identification device 40 to be seen from the outside of the front surface 30.

The back of the rear surface 20 of the mounting device 10 may have affixed an adhesive for attaching the sleeve to a mounting surface 50 such as a laptop computer, a portfolio, a personal digital assistant (PDA), a document or the like.

The adhesive may be a permanent adhesive to prevent removal of the mounting device 10 or may be a releasable adhesive to permit removal of the mounting device 10.

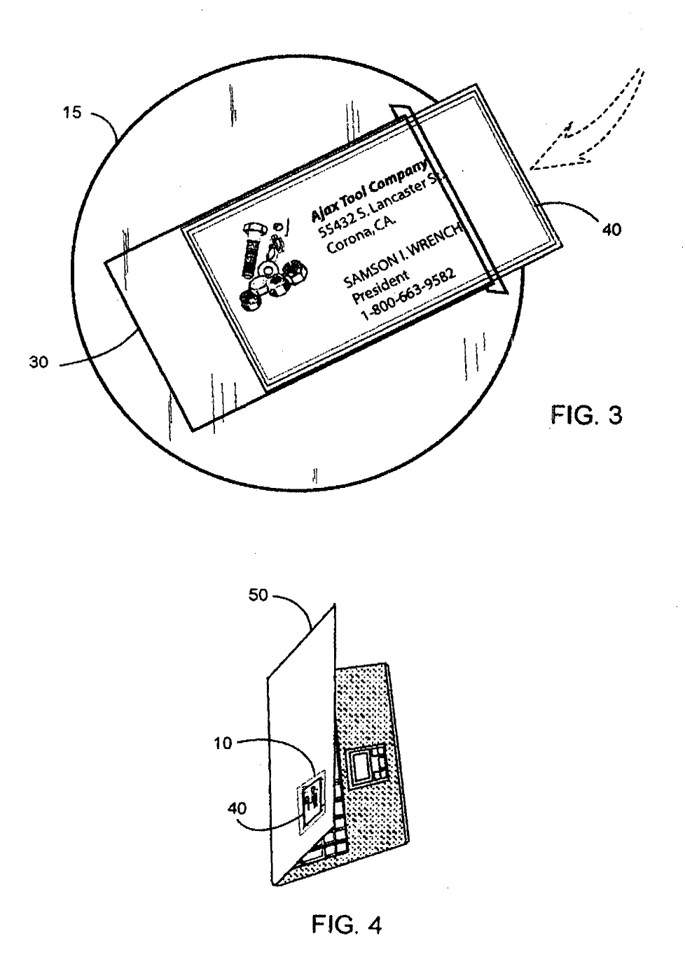

In an embodiment of the invention shown generally in FIG. 2 and FIG. 3, the mounting device 10 may be a plastic envelope with one or more openings 25 along an edge or on the face of the front of the mounting device 30 for insertion of an identification device 40 such as a business card.

In a similar embodiment of the invention shown generally in FIG. 4, an adhesive may be applied to the back of the rear surface 20 of the mounting device 10 and the envelope may be affixed to the device or item sought to be identified 50.

The mounting device 10 may be supplied individually with a backing material (not shown) that is releasably affixed to an adhesive applied to the back side of the rear surface 20 of the mounting device 10.

In an embodiment of the invention, the mounting device 10 may be supplied on a roll containing a plurality of sleeves with a backing material (not shown) that is releasably affixed to an adhesive applied to the back side of the rear surface 20 of the mounting device 10.

Although this invention has been described above with reference to particular means, materials and embodiments, it is to be understood that the invention is not limited to these disclosed particulars, but extends instead to all equivalents within the scope of the following claims.

What is claimed is:

1. A device for securing identification means to a mounting surface, comprising: an elongated mounting device having a front surface and a rear surface and a perimeter; the front surface being attached to the rear surface by at least a portion of the perimeter forming a pocket having at least one opening between the front surface and the rear surface; and an adhesive on the back of the rear surface to adhere the rear surface to the mounting surface.

2. The device of claim 1 wherein the front surface is substantially transparent.

3. The device of claim 1 wherein the adhesive has release characteristics so that the sleeve is removably adhered to the mounting surface and can be removed from the mounting surface without damaging the mounting surface.

4. A method for attaching identification means to a mounting surface, comprising: forming an elongated mounting device having a perimeter by attaching a front surface of the mounting device to a rear surface of the mounting device by at least a portion of the perimeter; and adhering the back of the rear surface of the mounting device to a mounting surface.

5. The method of claim 4 wherein the front surface is substantially transparent.

6. The method of claim 4 wherein the mounting device is removably adhered to the mounting surface and can be removed from the mounting surface without damaging the mounting surface.
